(19) United States
(12) Patent Application Publication
(10) Pub. No.: US 2023/0207863 A1
(43) Pub. Date: Jun. 29, 2023

(54) BATTERY

(71) Applicant: TOYOTA JIDOSHA KABUSHIKI KAISHA, Toyota-shi (JP)

(72) Inventor: Ryo KAGAMI, Ichinomiya-shi (JP)

(21) Appl. No.: 18/067,861

(22) Filed: Dec. 19, 2022

(30) Foreign Application Priority Data
Dec. 28, 2021 (JP) 2021-214240

(51) Int. Cl. H01M 10/0525; H01M 4/04; H01M 50/536

(52) U.S. Cl. CPC H01M 10/0525; H01M 4/0404; H01M 50/536

(57) ABSTRACT

A main object of the present disclosure is to provide a battery with excellent bonding of tabs and current collecting terminals. The present disclosure achieves the object by providing a battery including a power generating element, wherein: the power generating element includes a first active material layer, a second active material layer, an electrolyte layer arranged between the first active material layer and the second active material layer, a first current collector that collects currents of the first active material layer, and a second current collector that collects currents of the second active material layer; the first current collector includes a first tab; the battery includes a first current collecting terminal electronically connected to the first tab; in a plan view in a thickness direction of the power generating element, the first current collecting terminal includes a base part, and a protruding part that protrudes to the first tab side on the basis of the base part; the first tab includes a slit extending from an end part T₁ of the first current collecting terminal side to the first active material layer side; the slit contacts the protruding part; and the first tab includes a buckling part including the slit.

### TECHNICAL FIELD

The present disclosure relates to a battery.

### BACKGROUND ART

Batteries such as a lithium ion secondary battery usually includes a cathode current collector, a cathode active material layer, an electrolyte layer, an anode active material layer, and an anode current collector. The cathode current collector usually includes a cathode tab, and the cathode tab is electronically connected to a cathode current collecting terminal. Meanwhile, the anode current collector usually includes an anode tab, and the anode tab is electronically connected to an anode current collecting terminal. Patent Literature 1 discloses a joining method of joining a laminated structure in which a plurality of metal foils and a plurality of insulating films are layered, and a metal plate arranged in an end of the laminated structure.

### CITATION LIST

### Patent Literature

Patent Literature 1: Japanese Patent Application Laid-Open (JP-A) No. 2011-129328

### SUMMARY OF DISCLOSURE

### Technical Problem

In general, the thickness of a tab is thin, and thus unintended deformation tends to occur. When unintended deformation occurs, there is a possibility that the deformation may cause poor bonding of a tab and a current collecting terminal.

The present disclosure has been made in view of the above circumstances, and a main object thereof is to provide a battery with excellent bonding of tabs and current collecting terminals.

### Solution to Problem

The present disclosure provides a battery including a power generating element, wherein: the power generating element includes a first active material layer, a second active material layer, an electrolyte layer arranged between the first active material layer and the second active material layer, a first current collector that collects currents of the first active material layer, and a second current collector that collects currents of the second active material layer; the first current collector includes a first tab; the battery includes a first current collecting terminal electronically connected to the first tab; in a plan view in a thickness direction of the power generating element, the first current collecting terminal includes a base part, and a protruding part that protrudes to the first tab side on the basis of the base part; the first tab includes a slit extending from an end part T₁ of the first current collecting terminal side to the first active material layer side; the slit contacts the protruding part; and the first tab includes a buckling part including the slit.

According to the present disclosure, by arranging a slit in a tab, and by further arranging a buckling part including the slit, a battery with excellent bonding of tabs and current collecting terminals may be achieved.

In the disclosure, in a plan view in a thickness direction of the power generating element, an end part T_{S} of the first active material layer side of the slit may be positioned in outer side compared to an end part T_{F} of the first active material layer.

In the disclosure, the first current collecting terminal may include a plurality of the protruding part.

In the disclosure, the first tab may include a plurality of the slit with respect to one of the protruding part.

In the disclosure, the power generating element may be in a sheet shape.

### Advantageous Effects of Disclosure

The battery in the present disclosure exhibits an effect of excellent bonding of tabs and current collecting terminals.

### BRIEF DESCRIPTION OF DRAWINGS

FIG. 1 is a schematic perspective view exemplifying the battery in the present disclosure.

FIG. 2 is a cross-sectional view of A-A in FIG. 1.

FIG. 3 is a cross-sectional view of B-B in FIG. 1.

FIGS. 4A and 4B are schematic plan views explaining the first tab and the first current collecting terminal in the present disclosure.

FIGS. 5A to 5D are schematic plan views and schematic cross-sectional views explaining the first tab in the present disclosure.

FIGS. 6A and 6B are schematic plan views explaining the first tab in the present disclosure.

FIGS. 7A and 7B are schematic cross-sectional views exemplifying the protruding part in the present disclosure.

FIGS. 8A to 8C are schematic perspective views exemplifying the first current collecting terminal in the present disclosure.

FIGS. 9A to 9F are schematic perspective views exemplifying the method for producing the battery in the present disclosure.

FIGS. 10A and 10B are schematic perspective views exemplifying the method for producing the battery in the present disclosure.

### DESCRIPTION OF EMBODIMENTS

The battery in the present disclosure is hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

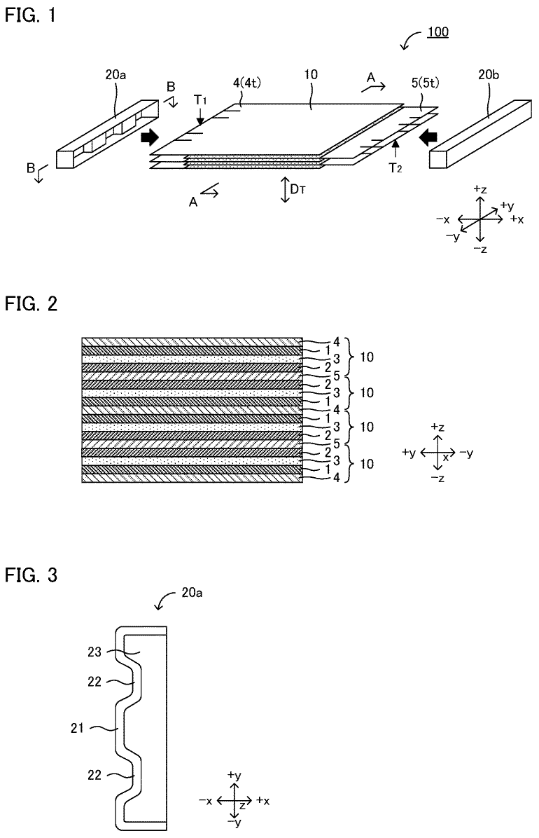

FIG. 1 is a schematic perspective view exemplifying the battery in the present disclosure. FIG. 2 is a cross-sectional view of A-A in FIG. 1, and in specific, it is a cross-sectional view of the power generating element cut in z axis, viewed from +x direction. FIG. 3 is a cross-sectional view of B-B in FIG. 1, and in specific, a cross-sectional view of the first current collecting terminal cut in x axis, viewed from −z direction.

Battery 100 illustrated in FIG. 1 comprises a plurality of power generating element 10. As shown in FIG. 2, the power generating element 10 includes first active material layer 1, second active material layer 2, electrolyte layer 3 arranged between the first active material layer 1 and the second active material layer 2, first current collector 4 that collects currents of the first active material layer 1, and second current collector 5 that collects currents of the second active material layer 2. Four of the power generating element 10 shown in FIG. 2 are connected in parallel to each other. Also, as shown in FIG. 1, the first current collector 4 includes first tab 4t.

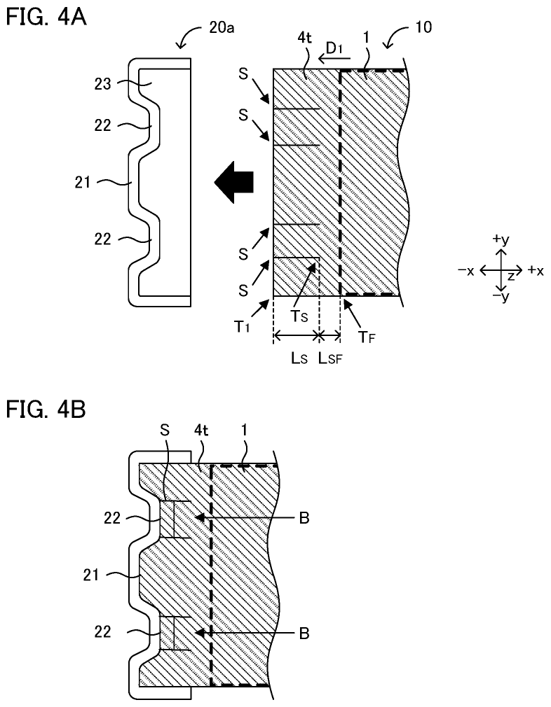

The battery 100 illustrated in FIG. 1 includes first current collecting terminal 20a electronically connected to the first tab 4t. Incidentally, for convenience, FIG. 1 illustrates the state of the first tab 4t and the first current collecting terminal 20a before electronically being connected. As shown in FIG. 3, the first current collecting terminal 20a includes base part 21, and protruding part 22 that protrudes to the first tab (not illustrated) side on the basis of the base part 21. Also, as shown in FIG. 4A, the first tab 4t includes slit S extending from end part T₁ of the first current collecting terminal 20a side to the first active material layer 1 side. As shown in FIG. 4B, the slit S contacts the protruding part 22, and the first tab 4t includes buckling part B including the slit S.

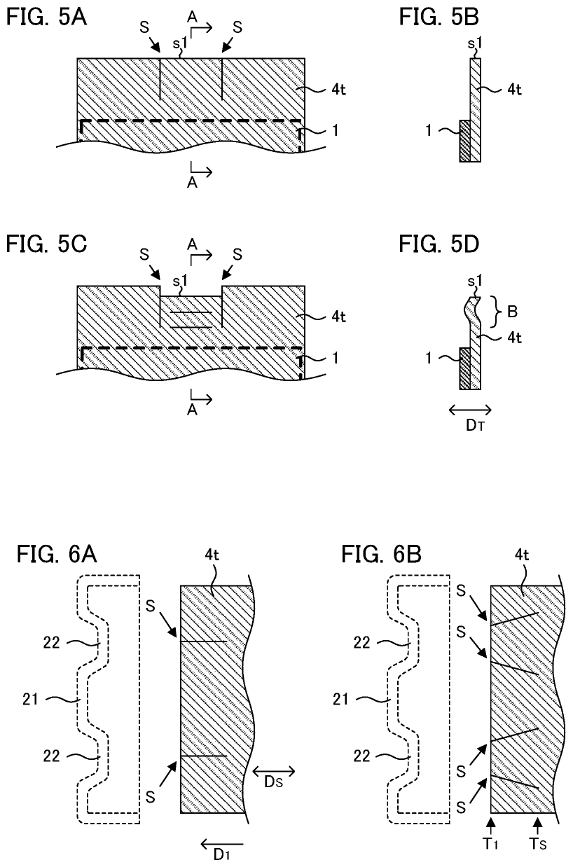

FIG. 5A is a schematic plan view exemplifying the first tab in the present disclosure, which shows the first tab before electronically being connected to the first current collecting terminal. FIG. 5B is a cross-sectional view of A-A in FIG. 5A. Meanwhile, FIG. 5C is a schematic plan view exemplifying the first tab in the present disclosure, which shows the first tab after electronically being connected to the first current collecting terminal. FIG. 5D is a cross-sectional view of A-A in FIG. 5C. First tab 4t shown in FIGS. 5A and 5B includes two slit S, and a side s1 positioned between the two slit S contacts a protruding part (not illustrated), and thereby moves to first active material layer 1 side. From this, as shown in FIGS. 5C and 5D, a part of the first tab 4t buckles in outersurface deformation manner in thickness direction D_{T}, and thereby buckling part B including the slit S is formed.

According to the present disclosure, by arranging a slit in a tab, and by further arranging a buckling part including the slit, a battery with excellent bonding of tabs and current collecting terminals may be achieved. As described above, in general, the thickness of a tab is thin, and thus unintended deformation tends to occur. When unintended deformation occurs, there is a possibility that the deformation may cause poor bonding of a tab and a current collecting terminal. For example, when unintended deformation occurs in the root of the tab, the deformed tab may contact other parts with different polarity to possibly cause short circuit. In particular, when a current collecting terminal and a tab are bonded by pushing the current collecting terminal including a protruding part against the tab, the current collecting terminal and the tab may be strongly bonded, but on the other hand, the deformation of the tab may easily occur due to the protruding part. In contrast, in the present disclosure, a slit is arranged in the tab. Thereby, when the current collecting terminal including the protruding part is pushed against the tab, a buckling part including the slit is formed. In this manner, by arranging the slit in the tab, and by positively arranging the part where the buckling occurs, the deformation of the tab can be controlled. As a result, a battery with excellent bonding of tabs and current collecting terminals may be achieved.

1. Power Generating Element

The power generating element in the present disclosure includes a first active material layer, a second active material layer, an electrolyte layer arranged between the first active material layer and the second active material layer, a first current collector that collects currents of the first active material layer, and a second current collector that collects currents of the second active material layer.

In the present disclosure, when the first active material layer is a cathode active material layer, the first current collector is a cathode current collector, the second active material layer is an anode active material layer, and the second current collector is an anode current collector. In contrast, when the first active material layer is an anode active material layer, the first current collector is an anode current collector, the second active material layer is a cathode active material layer, and the second current collector is a cathode current collector.

(1) First Current Collector

The first current collector in the present disclosure is electronically connected to the first active material layer, and collects currents of the first active material layer. The first current collector is, for example, arranged in the surface of the first active material layer that is opposite to the electrolyte layer. Also, as shown in FIG. 4A, first current collector 4 includes first tab 4t. The first tab 4t is arranged in a region not overlapping the first active material layer 1 in the thickness direction (z axis direction) of the power generating element 10. For example, when the first active material layer 1 is formed by a coating method, the first tab 4t is an uncoated part where the first active material layer is not formed.

As shown in FIG. 4A, the first tab 4t extends from end part T_{F} of the first active material layer 1 toward outside, and that extending direction is regarded as D₁. The extending direction D₁ crosses the thickness direction D_{T} of the power generating element 10. The extending direction D₁ in FIG. 4A corresponds to a direction (x axis direction) orthogonally intersects the thickness direction D_{T} (z axis direction) of the power generating element 10. The angle (acute angle side) formed by the extending direction D₁ of the first tab 4t and the thickness direction D_{T} of the power generating element 10 is, for example, 60° or more and 90° or less, may be 75° or more and 90° or less, and may be 80° or more and 90° or less.

As shown in FIG. 4A, in a plan view in the thickness direction (z axis direction) of the power generating element 10, the first tab 4t includes a slit S extending from an end part T₁ of the first current collecting terminal side to the first active material layer 1 side. The shape of the slit S in a plan view may be in straight line, and may be in curved line. Also, T_{S} designates the end part of the slit S in the first active material layer 1 side, and Ls designates a length from the end part T₁ until the end part T_{S}. The Ls is, for example, 0.1 mm or more and may be 1 mm or more. Meanwhile, the L_{S} is, for example, 30 mm or less, and may be 5 mm or less.

Also, as shown in FIG. 4A, the end part T_{S} is preferably positioned in the outer side compared to the end part T_{F}. In other words, it is preferable that there is a region where the slit S is not present between the end part T_{S} and the end part T_{F}. The reason therefor is to suppress the deformation of the root of the first tab. A length (shortest length) from the end part T_{S} until the end part T_{F} is regarded as L_{SF}. The L_{SF} is, for example, 0.1 mm or more and may be 1 mm or more. Meanwhile, the L_{SF} is, for example, 30 mm or less and may be 5 mm or less.

Also, as shown in FIG. 4B, slit S usually contacts protruding part 22. First tab 4t shown in FIG. 4B includes two slit S with respect to one protruding part 22. In this manner, the first tab 4t may include a plurality of the slit S with respect to one protruding part 22. When a plurality of the slit S is formed with respect to one protruding part 22, the buckling part may be stably formed. Meanwhile, as shown in FIG. 6A, the first tab 4t may include just one slit S with respect to one protruding part 22. In that case, there is an advantage that the producing process can be simplified.

As shown in FIG. 6A, Ds designates an extending direction of the slit S. The angle (acute angle side) formed by the extending direction D_{S} and the extending direction D₁ (extending direction of the first tab 4t) is, for example, 0° or more and 45° or less, and may be 0° or more and 30° or less. Also, as shown in FIG. 6B, the first tab 4t preferably includes a plurality of slit S with respect to one protruding part 22, and a distance between slit S neighboring preferably increases from the end part T₁ toward the end part T_{S}. Thereby, deformation of outersurface of the buckling part does not easily occur. Meanwhile, as shown in FIG. 4A, the first tab 4t may include a plurality of slit S with respect to one protruding part 22, and the distance between slit S neighboring may be the same from the end part T₁ toward the end part T_{S}. “Same” means that the difference in the maximum value and the minimum value of the distance between slit S neighboring is 1 mm or less from the end part T₁ toward the end part T_{S}.

The first current collector in the present disclosure is a cathode current collector or an anode current collector. Examples of the material for the cathode current collector may include a metal such as aluminum, SUS, and nickel. Examples of the material for the anode current collector may include a metal such as copper, SUS, and nickel. Examples of the shape of the first current collector may include a foil shape and a mesh shape. The thickness of the first current collector is, for example, 200 μm or less, and may be 20 μm or less. Meanwhile, the thickness of the first current collector is, for example, 5 μm or more.

(2) Second Current Collector

The second current collector in the present disclosure is electronically connected to the second active material layer, and collects currents of the second active material layer. The second current collector is, for example, arranged in the surface of the second active material layer that is opposite from the electrolyte layer. Also, as shown in FIG. 1, the second current collector 5 may include second tab 5t. The second tab is usually arranged in a region not overlapping the second active material layer in the thickness direction of the power generating element.

As shown in FIG. 1, the second tab 5t may include a slit extending from end part T₂ of the second current collecting terminal 20b side to the second active material layer (not illustrated) side. The preferable embodiments of the second tab are the same as the preferable embodiments of the first tab described above; thus the descriptions herein are omitted. Also, as shown in FIG. 1, the second tab 5t and the first tab 4t may be arranged respectively in a side of the power generating element 10 facing to each other. Such a structure is called a double-tab structure. Meanwhile, although not illustrated in particular, the second tab and the first tab may be arranged in the same side of the power generating element. Such a structure is called a single-tab structure.

(3) First Active Material Layer, Second Active Material Layer, and Electrolyte Layer

The first active material layer in the present disclosure is a cathode active material layer or an anode active material layer. The second active material layer in the present disclosure has the polarity opposite to that of the first active material layer.

The cathode active material layer contains at least a cathode active material. The cathode active material layer may further contain at least one of a conductive material, an electrolyte and a binder. Examples of the cathode active material may include an oxide active material. Examples of the oxide active material may include a rock salt bed type active material such as LiNi_{1/3}Co_{1/3}Mn_{1/3}O₂; a spinel type active material such as LiMn₂O₄; and an olivine type active material such as LiFePO₄. Also, as the cathode active material, sulfur (S) may be used. Examples of the shape of the cathode active material may include a granular shape.

Examples of the conductive material may include a carbon material. The electrolyte may be a solid electrolyte and may be an electrolyte solution. The solid electrolyte may be an organic solid electrolyte such as a gel electrolyte, and may be an inorganic solid electrolyte such as an oxide solid electrolyte and a sulfide solid electrolyte. Also, the electrolyte solution (liquid electrolyte) contains, for example, a supporting electrolyte such as LiPF₆, and a solvent such as a carbonate-based solvent. Also, examples of the binder may include a rubber-based binder and a fluoride-based binder.

The anode active material layer contains at least an anode active material. The anode active material layer may further contain at least one of a conductive material, an electrolyte, and a binder. Examples of the anode active material may include a metal active material such as Li and Si, a carbon active material such as graphite, and an oxide active material such as Li₄Ti₅O₁₂. Examples of the shape of the anode active material may include a granular shape and a foil shape. The conductive material, the electrolyte, and the binder are in the same contents as those described above.

The electrolyte layer is arranged between the cathode active material layer and the anode active material layer, and contains at least an electrolyte. The electrolyte may be a solid electrolyte and may be an electrolyte solution. The electrolyte is in the same contents as those described above. The electrolyte layer may include a separator.

(4) Power Generating Element

The power generating element in the present disclosure may be in a sheet shape and may be in a winding shape. In the case of the sheet shape, in structure wise, unintended deformation may easily occur in a tab, but in the present disclosure, by arranging a slit in the tab and further arranging a buckling part, occurrence of the unintended deformation in the tab can be inhibited. Meanwhile, in the case of the winding shape, since the first tab is winded in a spiral shape, the rigidity of the first tab is improved by the circular arc part of the spiral. On the other hand, for example, when the power generating element is in a plane winding shape (a plane shape is formed by pressing the power generating element in a winding shape), deformation of the first tab tends to occur in that flat part. In that point, the effect of the present disclosure can be exhibited better when the power generating element is in the plane winding shape compared to when the power generating element is in a winding shape where the first tab is winded in a spiral shape. The battery preferably includes a plurality of the power generating element. Also, when the battery includes a plurality of the power generating element, a plurality of the first tab may not be bonded to each other but may be electronically connected to the first current collecting terminal.

2. Current Collecting Terminal

The battery in the present disclosure includes a first current collecting terminal electronically connected to the first tab. Also, the battery in the present disclosure includes a second current collecting terminal electronically connected to the second tab. There are no particular limitations on the material of these current collecting terminals, and examples thereof may include a metal such as SUS.

As shown in FIG. 4A, in a plan view in a thickness direction (z axis direction) of the power generating element 10, the first current collecting terminal 20a includes base part 21, and protruding part 22 that protrudes to the first tab 4t side on the basis of the base part 21. As shown in FIG. 4B, the protruding part 22 contacts the first tab 4t. The base part 21 may or may not contact the first tab 4t, but the former is preferable. The reason therefor is to decrease the internal resistance.

The first current collecting terminal includes at least a base part and a protruding part. The shape of the base part in a plan view (outer periphery shape of the base part in a plan view in the thickness direction) is, for example, in a square shape such as a rectangular shape and a foursquare shape. Meanwhile, the first current collecting terminal may include just one protruding part, and may include a plurality of the protruding part. In the latter case, the plurality of the protruding part is preferably arranged regularly in a fixed pitch. Also, the protruding part has a shape that protrudes to the first tab side on the basis of the base part. Here, FIGS. 7A and 7B are schematic cross-sectional views exemplifying the first current collecting terminal, similarly to FIG. 3. As shown in FIG. 7A, H designates the height (length from base part 21) of the protruding part 22, and W designates the width (length of the direction orthogonally intersects the height H) of the protruding part 22. The H is, for example, 0.1 mm or more and may be 1 mm or more. Meanwhile, the H is, for example, 50 mm or less and may be 30 mm or less. Also, the W is, for example, 1 mm or more and may be 5 mm or more. Meanwhile, the W is, for example, 50 mm or less and may be 10 mm or less.

As shown in FIG. 7A, top surface t of the protruding part 22 may be in a plane shape. The top surface t contacts the first tab (not illustrated). The width of the top surface t with respect to the W is, for example, 0.5 times or more, may be 0.7 times or more, and may be 0.9 times or more. Meanwhile, the width of the top surface t with respect to the W is, for example, 1 time or less. Also, as shown in FIG. 7B, the protruding part 22 may be in a curved shape.

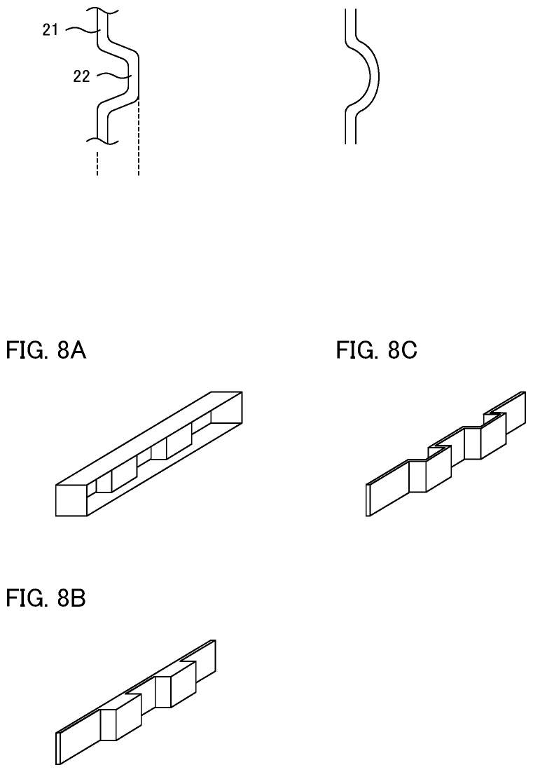

The first current collecting terminal may include one or two or more of a wall part arranged so as to share a side of the base part. By arranging the wall part, the rigidity of the first current collecting terminal improves. Also, by arranging the wall part, for example, when unintended deformation occurs in a tab, occurrence of short circuit can be inhibited. For example, first current collecting terminal 20a shown in FIG. 8A includes wall part 23 and wall part 24 arranged so as to share a longer side of the base part 21. For example, the wall part 24 configures a top surface of the first current collecting terminal 20a, and the wall part 23 configures a bottom surface of the first current collecting terminal 20a. Further, the first current collecting terminal 20a shown in FIG. 8A includes wall part 25 and wall part 26 arranged so as to share a shorter side of the base part 21. For example, the wall part 25 and the wall part 26 respectively configure a side surface of the first current collecting terminal 20a. Meanwhile, as shown in FIG. 8B, the first current collecting terminal 20a may include just the base part 21 and the protruding part 22. Also, as shown in FIG. 8C, the first current collecting terminal 20a may include groove part 27 corresponding to the protruding part 22.

Meanwhile, the second current collecting terminal may include a base part, and a protruding part that protrudes to the second tab side on the basis of the base part, similarly to the first current collecting terminal. Further, a slit in the second tab may contact the protruding part in the second current collecting terminal, and the second tab may include a buckling part including the slit. Preferable embodiments of the second current collecting terminal are the same as the preferable embodiments of the first current collecting terminal described above; thus the descriptions herein are omitted.

3. Battery

The battery in the present disclosure may include an outer package that stores the power generating element. Examples of the outer package may include a laminate type outer package and a case type outer package. Also, the kind of the battery in the present disclosure is not particularly limited, but is typically a lithium ion secondary battery. Further, the application of the battery in the present disclosure is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles or battery electric vehicles. Also, the battery in the present disclosure may be used as a power source for moving bodies other than vehicles (such as rail road transportation, vessel and airplane), and may be used as a power source for electronic products such as information processing equipment.

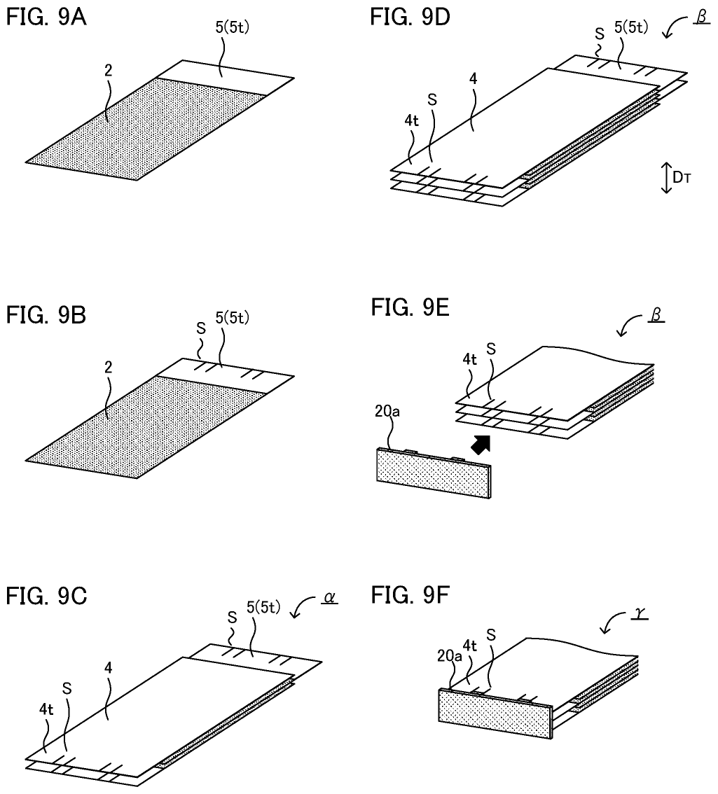

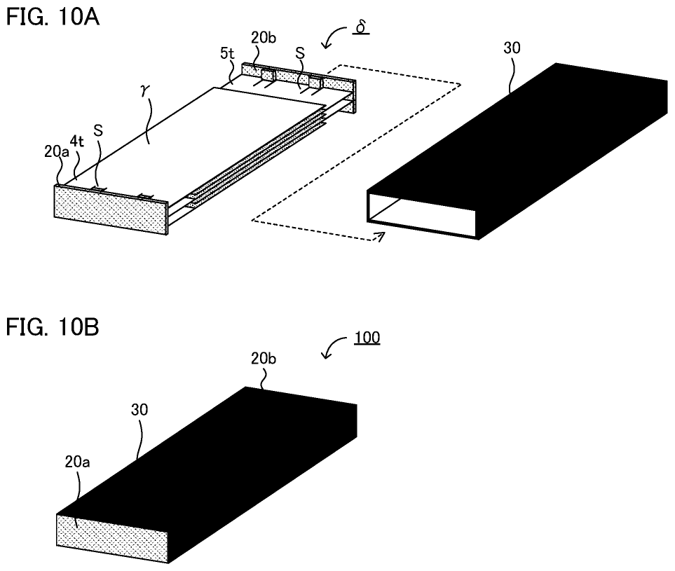

There are no particular limitations on the method for producing the battery in the present disclosure. FIGS. 9A to 9F and FIGS. 10A and 10B are schematic perspective views exemplifying the method for producing the battery in the present disclosure. First, as shown in FIG. 9A, second active material layer 2 is respectively formed on both surfaces of the second current collector 5. Examples of the method for forming the second active material layer may include a method of pasting a slurry containing the material of the second active material layer on the second current collector, and drying thereof. Next, as shown in FIG. 9B, slit S is formed in second tab 5t. Examples of the method for forming the slit S may include cutting by a blade, and cutting by a laser. Next, as shown in FIG. 9C, an electrolyte layer (not illustrated), a first active material layer (not illustrated), and first current collector 4 are respectively arranged on two of the second active material layer 2 to obtain a layered body α. Regarding the slit S of the first tab 4t, the slit S may be formed in the first tab 4t in advance before arranging the first current collector 4, and the slit S may be formed in the first tab 4t after arranging the first current collector 4.

After that, as shown in FIG. 9D, two of the layered body α are layered in thickness direction D_{T} to produce a layered body β. Next, as shown in FIG. 9E, with respect to the first tab 4t in which the slit S is formed, first current collecting terminal 20a is pushed into from the side surface of the layered body β (side surface of the power generating element), and then the layered body β and the first current collecting terminal 20a are bonded to produce a layered body γ. Examples of the method for bonding the layered body β and the first current collecting terminal 20a may include a method using welding such as a laser welding method, and an electron beam welding, a method using a conductive paste, and a method using a solder. Next, as shown in FIG. 10A, in the same manner as the first current collecting terminal 20a, the layered body γ and the second current collecting terminal 20b are bonded to produce a layered body δ. Further, the layered body δ is stored in outer package 30. Next, as shown in FIG. 10B, the space between the first current collecting terminal 20a and the outer package 30 is sealed, and the space between the second current collecting terminal 20b band the outer package 30 is sealed in the same manner. Examples of the method for sealing may include a calking treatment and a laminating treatment. In this manner, battery 100 is obtained.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### REFERENCE SIGNS LIST

1 first active material layer
2 second active material layer
3 electrolyte layer
1 first current collector
4t first tab
5 second current collector
5t second tab
10 power generating element
20a first current collecting terminal
20b second current collecting terminal
100 battery

What is claimed is:

1. A battery comprising a power generating element, wherein:
the power generating element includes a first active material layer, a second active material layer, an electrolyte layer arranged between the first active material layer and the second active material layer, a first current collector that collects currents of the first active material layer, and a second current collector that collects currents of the second active material layer;
the first current collector includes a first tab;
the battery includes a first current collecting terminal electronically connected to the first tab;
in a plan view in a thickness direction of the power generating element, the first current collecting terminal includes abase part, and a protruding part that protrudes to the first tab side on the basis of the base part;
the first tab includes a slit extending from an end part T₁ of the first current collecting terminal side to the first active material layer side;
the slit contacts the protruding part; and
the first tab includes a buckling part including the slit.

2. The battery according to claim 1, wherein, in a plan view in a thickness direction of the power generating element, an end part T_{S} of the first active material layer side of the slit is positioned in outer side compared to an end part T_{F} of the first active material layer.

3. The battery according to claim 1, wherein the first current collecting terminal includes a plurality of the protruding part.

4. The battery according to claim 1, wherein the first tab includes a plurality of the slit with respect to one of the protruding part.

5. The battery according to claim 1, wherein the power generating element is in a sheet shape.
